(19) United States
(12) Patent Application Publication
(10) Pub. No.: US 2002/0154945 A1
(43) Pub. Date: Oct. 24, 2002

(54) Elevator load bearing termination assembly with constant profile extrusion

(76) Inventor: Richard J. Ericson, (US)

Correspondence Address: David J. Gaskey, CARLSON, GASKEY & OLDS, P.C., 400 West Maple Road, Suite 350, Birmingham, MI, 48009, US

(21) Appl. No.: 09/837,825

(22) Filed: Apr. 18, 2001

(51) Int. Cl. F16B 2/14; F16B 2/18; B25G 3/20; F16B 7/04

(52) U.S. Cl. 403/374.1

(57) ABSTRACT

A device for handling an end on a load bearing member in an elevator system includes a socket portion and a wedge portion. The socket and wedge preferably are made from an extruded piece of metal or a formed piece of sheet metal material. A brace member secures the wedge within the socket portion to maintain the wedge, and the corresponding portion of the load bearing member in place within the socket portion. The preferred arrangement includes friction enhancing surfaces on the corresponding portions of the socket and the wedge to facilitate maintaining the load bearing member in place.

### BACKGROUND OF THE INVENTION

This invention generally relates to elevator support systems. More particularly, this invention relates to a device for securing an end of a load bearing arrangement in an elevator system.

Elevator systems typically include some form of load bearing member, such as roping or a belt for supporting and moving the cab through the hoistway as desired. In some situations, the belt couples a counterweight to the cab.

Regardless of the specific configuration of the elevator system, it typically is necessary to secure ends of the belt to an appropriate structure within the elevator system. A variety of configurations of assemblies for securing the ends of a belt in an elevator system have been used. One example includes a cast, socket and wedge arrangement where a portion of the belt is secured between a socket and wedge. One drawback associated with currently used arrangements is that the casting process is relatively expensive. Another shortcoming of current systems is that the casting process is not accurate enough to provide the dimensional tolerances needed for many situations.

There is a need for an improved elevator load bearing termination arrangement. This invention addresses that need, overcomes the shortcomings described above and provides significant cost savings.

### SUMMARY OF THE INVENTION

In general terms, this invention is a device for accommodating an end of a load bearing member in an elevator system. The device includes an extruded socket and an extruded wedge. The socket has an interior surface against which a portion of the load bearing member is received. The wedge has an exterior surface that is received against the load bearing member when the wedge is positioned within the socket. At least one brace member supports the socket and assists maintaining the wedge in position within the socket.

In the preferred embodiment the wedge and socket have corresponding surfaces that engage the load bearing member. The engaging surfaces preferably have a constant profile. In one example, the load bearing member engaging surfaces have a friction-enhancing surface.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 diagrammatically illustrates a device designed according to this invention.

FIG. 2 is a cross sectional view of a selected portion of the embodiment of FIG. 1.

FIG. 3 illustrates a preferred detail of a portion of the embodiment of FIG. 1.

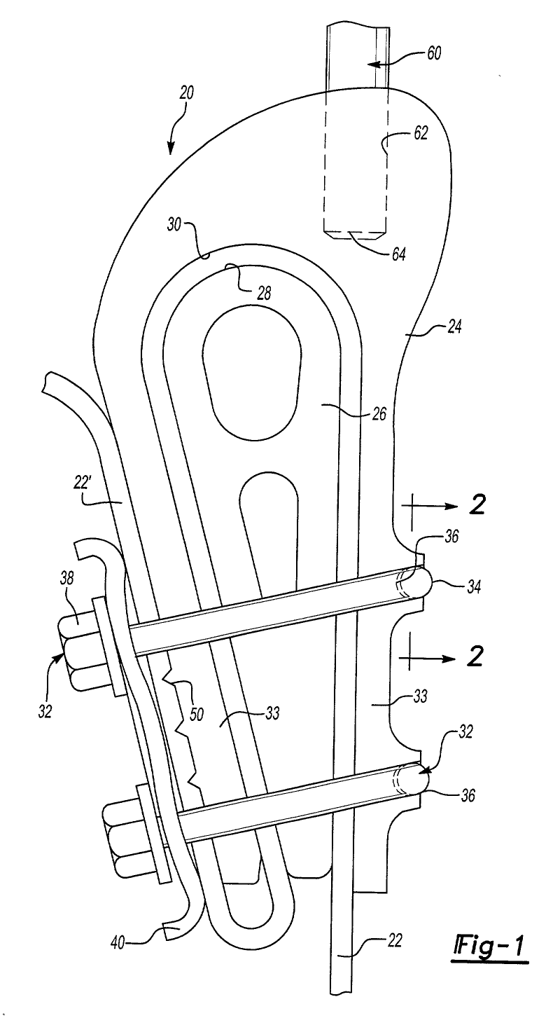

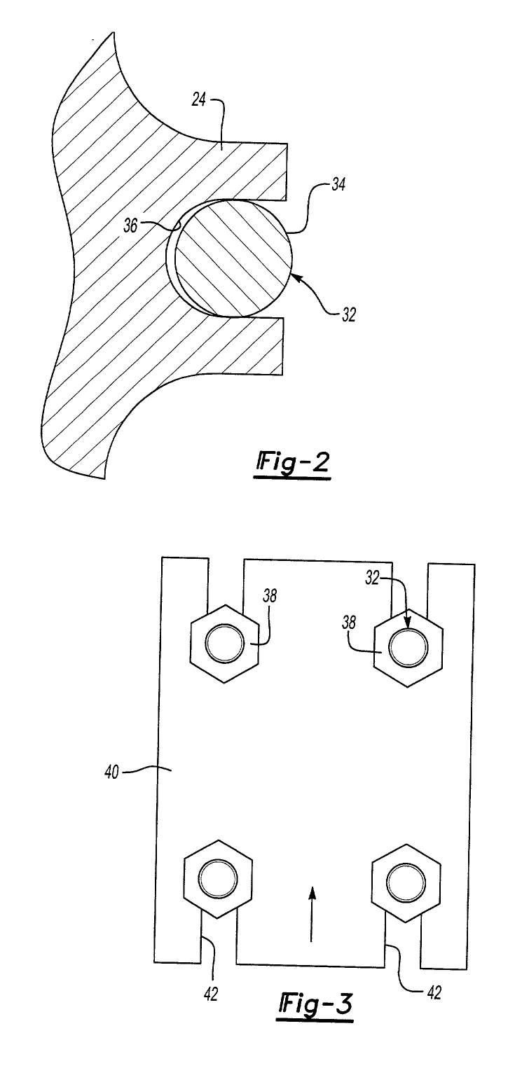

### DETAILED DESCRIPTION OF THE PREFERRED EMBODIMENT

A device 20 for handling an end of a load bearing member 22 in an elevator system includes a socket portion 24 and a wedge portion 26. The load bearing member 22 in the illustrated example is a coated steel belt. This invention is not limited, however, to coated steel belts. Rather, any load bearing member within an elevator system that can be accommodated using a socket and wedge arrangement designed according to this invention may be used. The term “belt” as used in this description should not be construed in its strictest sense. It should be considered synonymous with roping or load bearing member.

The socket portion 24 and wedge portion 26 preferably are extruded or otherwise formed from sheet metal material. An extrusion or other sheet metal forming process provide the advantage of achieving close tolerances and manufacturing economies. Using an extrusion process or otherwise forming sheet metal, allows for the cooperating surfaces on the socket portion 24 and the wedge portion 26 to be exactly parallel. A constant profile cross section on each is preferred to ensure stability in securing the end of the load bearing member 22. Additionally, using the extrusion or other sheet metal forming process permits a cost savings on the order of fifty percent compared to conventional casting processes. Given this description, those skilled in the art will realize whether an extrusion or other forming process best suits the needs of their particular situation.

The wedge portion 26 has an outer surface 28 that is received against the belt 22 when the wedge 28 is positioned within the socket 24. An inner surface 30 on the socket portion 24 engages the other side of the belt 22. Accordingly, the belt 22 is secured between the wedge portion 26 and socket portion 24 so that it is held in place. In the preferred embodiment, the outer surface 28 on the wedge portion has a friction enhanced surface. In one example, the surface is knurled. In another example, the outer surface 28 on the wedge portion is roughened using a sandblasting or other conventional technique. Similarly, the inner surface 30 on the socket portion 24 preferably has a friction enhanced texture.

The preferred arrangement includes at least one brace member 32 that maintains the legs 33 of the socket portion 24 in position to hold on to the wedge portion 26 and the corresponding portion of the belt 22. The illustrated example includes two U-bolts 32 that operate as the brace member. Because the socket portion 24 is preferably extruded, it may be susceptible to being pried open by the forces imposed on the wedge portion 26 as the load bearing member 22 is under tension in the elevator system.

A portion 34 of the U-bolts 32 preferably is received within a corresponding surface 36 on the socket portion 24. The preferred arrangement includes a configuration of the receiver portion 36 such that the portion 34 of each U-bolt snaps and locks into place against the socket 24. The U-bolt preferably is rotatable about the axis of the portion 34 after it has been snapped into place on the socket portion 24. Conventional nuts 38 preferably are used to secure the legs 33 of the socket portion 24 into the desired position.

The preferred arrangement includes a securing member 40 that secures a terminal end 22′ of the load bearing member 22 against an outer surface on the socket 24. The illustrated example securing member 40 is a spring clip. The spring clip preferably cooperates with the brace members 32 to hold the terminal end 22′ of the belt in place. The spring clip 40 further serves the purpose of maintaining steel load bearing members in position even in the event that a urethane coating, for example, on the belt 22 were to be damaged.

The spring clip 40 preferably includes slot portions 42 that receive corresponding portions of the U-bolts 32. During assembly, the spring clip 40 can be positioned in place and the U-bolts rotated about the axis of the portions 34 until the bolts are appropriately received within the slots 42. Then the nuts 38 are appropriately tightened to properly secure the end of the belt 22 in place.

The outer surface of the socket preferably includes a friction enhancing surface 50 that facilitates maintaining the end 22′ of the belt against the outer surface of the socket portion 24. In one example, the friction enhancing surface includes raised portions on the outer surface that effectively grip the belt.

The assembly 20 facilitates securing the end of the belt 22 to another portion of the elevator system as is conventionally needed. The illustrated example shows a rod 60 that has a threaded end 62 that is received within a threaded opening 64 on the socket portion 24.

The preceding description is exemplary rather than limiting in nature. Variations and modifications to the disclosed embodiment may become apparent to those skilled in the art that do not necessarily depart from the purview and spirit of this invention. The scope of legal protection given to this invention can only be determined by studying the following claims.

I claim:

1. A device for handling an end of an elongated load bearing member in an elevator system, comprising:
a socket portion;
a wedge portion that is at least partially received within the socket portion such that a portion of the elongated load bearing member is received between the socket portion and the wedge portion; and
at least one brace member that secures the wedge portion within the socket portion.

2. The device of claim 1, wherein the socket portion is an extruded metal piece.

3. The device of claim 1, wherein the wedge portion is an extruded metal piece.

4. The device of claim 1, wherein the socket portion and the wedge portion have a constant cross sectional profile.

5. The device of claim 1, wherein the brace member comprises a U-bolt.

6. The device of claim 5, wherein the socket portion includes a receiver portion that receives a corresponding portion of the U-bolt and permits the U-bolt to move about the axis of the corresponding portion relative to the socket portion.

7. The device of claim 6, including a securing member that secures a terminal end of the elongated load bearing member against an outer surface on the socket portion.

8. The device of claim 7, wherein the securing member comprises a spring clip.

9. The device of claim 8, wherein the spring clip includes a plurality of slots for receiving a portion of the U-bolt as the U-bolt is moved relative to the socket portion.

10. A device for handling an end of an elongated load bearing member in an elevator system, comprising:
an extruded socket portion; and
an extruded wedge portion that is at least partially received within the socket portion such that a portion of the elongated load bearing member is received between the socket portion and the wedge portion.

11. The device of claim 10, including at least one brace member that secures the wedge portion within the socket portion.
